(19) United States
(12) Patent Application Publication
(10) Pub. No.: US 2025/0183445 A1
(43) Pub. Date: Jun. 5, 2025

(54) ALL-SOLID RECHARGEABLE BATTERY

(71) Applicant: SAMSUNG SDI CO., LTD., Yongin-si (KR)

(72) Inventors: Isaac SHIN, Yongin-si (KR); Riyul KIM, Yongin-si (KR); Kwang Jong SUH, Yongin-si (KR); Young Gyoon RYU, Yongin-si (KR)

(21) Appl. No.: 18/926,442

(22) Filed: Oct. 25, 2024

(30) Foreign Application Priority Data
Nov. 30, 2023 (KR) 10-2023-0171627

(51) Int. Cl. H01M 50/242; H01M 50/291

(52) U.S. Cl. CPC H01M 50/242; H01M 50/291

(57) ABSTRACT

An all-solid rechargeable battery includes an all-solid cell stack including a plurality of all-solid unit cells stacked in a first direction; a case accommodating the all-solid cell stack therein; a first end plate between the first end portion of the all-solid cell stack in the first direction and the case; and a plurality of first metal wave springs between the first end plate and the case.

### CROSS-REFERENCE TO RELATED APPLICATION

This application claims priority to and the benefit of Korean Patent Application No. 10-2023-0171627 filed in the Korean Intellectual Property Office on Nov. 30, 2023, the entire contents of which are incorporated herein by reference.

### BACKGROUND

### 1. Field

Embodiments relate to an all-solid rechargeable battery.

### 2. Description of the Related Art

Recently, as a risk of an explosion in batteries using liquid electrolytes has been reported, the development of all-solid rechargeable batteries has been considered. The all-solid rechargeable battery refers to a battery in which all materials are made of solids and uses a solid electrolyte.

### SUMMARY

The embodiments may be realized by providing an all-solid rechargeable battery including an all-solid cell stack including a plurality of all-solid unit cells stacked in a first direction; a case accommodating the all-solid cell stack therein; a first end plate between a first end portion of the all-solid cell stack in the first direction and the case; and a plurality of first metal wave springs between the first end plate and the case.

The plurality of first metal wave springs may be in contact with the first end plate.

The first end plate may include a plurality of first depressed portions spaced apart from each other in a second direction intersecting the first direction, and the plurality of first metal wave springs may be each inserted into the plurality of first depressed portions.

The all-solid rechargeable battery may further include a second end plate between the plurality of first metal wave springs and the case and in contact with the plurality of first metal wave springs.

The second end plate may include a plurality of second depressed portions spaced apart from each other in the second direction and corresponding to the plurality of first depressed portions of the first end plate, and the plurality of first metal wave springs may be each inserted into the plurality of second depressed portions.

The second end plate may be in contact with the case.

The plurality of first metal wave springs may be in contact with the case.

The plurality of first metal wave springs may each include a ring type wave spring.

The ring type wave spring may include a wave spring of which waves with a shape symmetrical to each other are stacked and extended in a direction in which the wave spring is elastically biased.

The ring type wave spring may include a wave spring in which a single-layer wave is extended in a ring shape.

The ring type wave spring may include a wave spring in which waves of the same shape are stacked and extended in a direction in which the wave spring is elastically biased.

The all-solid rechargeable battery may further include a third end plate between a second end portion of the all-solid cell stack in the first direction and the case; and a plurality of second metal wave springs between the third end plate and the case.

The plurality of second metal wave springs may contact the third end plate.

The third end plate may include a plurality of third depressed portions spaced apart from each other in a second direction intersecting the first direction, and the plurality of second metal wave springs may be each inserted into the plurality of third depressed portions.

The all-solid rechargeable battery may further include a fourth end plate positioned between the plurality of second metal wave springs and the case and in contact with the plurality of second metal wave springs.

The fourth end plate may include a plurality of fourth depressed portions spaced apart from each other in the second direction and corresponding to the plurality of third depressed portions of the third end plate, and the plurality of second metal wave springs may be each inserted into the plurality of fourth depressed portions.

The fourth end plate may be in contact with the case.

The plurality of second metal wave springs may be in contact with the case.

The all-solid cell stack may further include a plurality of cushioning pads between the plurality of all-solid unit cells.

Each of the all-solid unit cells may include a negative electrode; a positive electrode on the negative electrode; and a solid electrolyte layer between the negative electrode and the positive electrode.

### BRIEF DESCRIPTION OF THE DRAWINGS

Features will be apparent to those of skill in the art by describing in detail exemplary embodiments with reference to the attached drawings in which:

FIG. 1 is a cross-sectional view of an all-solid battery.

FIG. 2 is a cross-sectional view of an all-solid battery including a precipitated negative electrode.

FIG. 3 is a cross-sectional view showing an all-solid rechargeable battery according to an embodiment.

FIG. 4 is an enlarged cross-sectional view of a part A in FIG. 3.

FIG. 5 is a view showing an example of a first metal wave spring of an all-solid rechargeable battery according to an embodiment.

FIG. 6 is a view showing another example of a first metal wave spring of an all-solid rechargeable battery according to an embodiment.

FIG. 7 is a view showing another example of a first metal wave spring of an all-solid rechargeable battery according to an embodiment.

FIG. 8 is an enlarged cross-sectional view of a part B in FIG. 3.

FIG. 9 is a cross-sectional view showing an all-solid rechargeable battery according to another embodiment.

### DETAILED DESCRIPTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

In addition, unless explicitly described to the contrary, the word “comprise”, and variations such as “comprises” or “comprising”, will be understood to imply the inclusion of stated elements but not the exclusion of any other elements.

In order to clearly express multiple layers and regions in the drawing, the thickness may be enlarged and shown. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface. Herein, “or” is not to be construed as an exclusive meaning, for example, “A or B” is construed to include A, B, A+B, and the like.

A Positive Electrode for an all-Solid Rechargeable Battery

In an embodiment, as a positive electrode for an all-solid rechargeable battery including a current collecting layer and a positive active material layer on the current collecting layer, the positive electrode for the all-solid rechargeable battery having the positive active material layer may include a positive active material, a sulfide solid electrolyte, a binder, and a conductive material. In an implementation, the positive electrode for the all-solid rechargeable battery may include more or fewer components than the components described above.

In an implementation, the positive electrode for an all-solid rechargeable battery may be manufactured by coating a positive electrode composition including the positive active material, the sulfide solid electrolyte, the binder, and the conductive material to the current collecting layer, and then drying and rolling.

### A Positive Active Material

The positive active materials may be a suitable material for all-solid rechargeable batteries. In an implementation, the positive active material may be a compound capable of reversible intercalation and deintercalation of lithium, and may include a compound expressed by any of the following Chemical Formulas.
LiₐA_{1-b}X_{b}D′₂ (0.90≤a≤1.8, 0≤b≤0.5);
LiₐA_{1-b}X_{b}O_{2-c}D′_{c} (0.90≤a≤1.8, 0≤b≤0.5, 0≤c≤0.05);
LiₐE_{1-b}X_{b}O_{2-c}D′_{c} (0.90≤a≤1.8, 0≤b≤0.5, 0≤c≤0.05);
LiₐE_{2-b}X_{b}O_{4-c}D′_{c} (0.90≤a≤1.8, 0≤b≤0.5, 0≤c≤0.05);
LiₐNi_{1-b-c}Co_{b}X_{c}D′_{α} (0.90≤a≤1.8, 0≤b≤0.5, 0≤c≤0.5, 0<α≤2);
LiₐNi_{1-b-c}Co_{b}X_{c}O_{2-α}T_{α} (0.90≤a≤1.8, 0≤b≤0.5, 0≤c≤0.05, 0<α≤2);
LiₐNi_{1-b-c}Co_{b}X_{c}O_{2-α}T2 (0.90≤a≤1.8, 0≤b≤0.5, 0≤c≤0.05, 0<α<2);
LiₐNi_{1-b-c}Mn_{b}X_{c}D_{α} (0.90≤a≤1.8, 0≤b≤0.5, 0≤c≤0.05, 0<α≤2);
LiₐNi_{1-b-c}Mn_{b}X_{c}O_{2-α}T_{α} (0.90≤a≤1.8, 0≤b≤0.5, 0≤c≤0.05, 0<α<2);
LiₐNi_{1-b-c}Mn_{b}X_{c}O_{2-α}T₂ (0.90≤a≤1.8, 0≤b≤0.5, 0≤c≤0.05, 0<α<2);
LiₐNi_{b}E_{c}G_{d}O₂ (0.90≤a≤1.8, 0≤b≤0.9, 0≤c≤0.5, 0.001≤d≤0.1);
LiₐNi_{b}Co_{c}Mn_{d}GeO₂ (0.90≤a≤1.8, 0≤b≤0.9, 0≤c≤0.5, 0≤d≤0.5, 0.001≤e≤0.1);
LiₐNiG_{b}O₂ (0.90≤a≤1.8, 0.001≤b≤0.1);
LiₐCoG_{b}O₂ (0.90≤a≤1.8, 0.001≤b≤0.1);
LiₐMn_{1-b}G_{b}O₂ (0.90≤a≤1.8, 0.001≤b≤0.1);
LiₐMn₂G_{b}O₄ (0.90≤a≤1.8, 0.001≤b≤0.1);
LiₐMn_{1-g}G_{g}PO₄ (0.90≤a≤1.8, 0≤g≤0.5);
QO₂; QS₂; LiQS₂;
V₂O₅; LiV₂O₅;
LiZO₂;
LiNiVO₄;
Li_{(3-f)}J₂(PO₄)₃ (0≤f≤2);
Li_{(3-f)}Fe₂(PO₄)₃ (0≤f≤2);
LiₐFePO₄ (0.90≤a≤1.8).

In the above Chemical Formulas, A may be Ni, Co, Mn, or a combination thereof, X may be Al, Ni, Co, Mn, Cr, Fe, Mg, Sr, V, a rare earth element, or a combination thereof, D′ may be O, F, S, P, or a combination thereof, E may be Co, Mn, or a combination thereof, T may be F, S, P, or a combination thereof, G may be Al, Cr, Mn, Fe, Mg, La, Ce, Sr, V, or a combination thereof, Q may be Ti, Mo, Mn, or a combination thereof, Z may be Cr, V, Fe, Sc, Y, or a combination thereof, and J may be V, Cr, Mn, Co, Ni, Cu, or a combination thereof.

The positive active materials, e.g., may include lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), or lithium iron phosphate oxide (LFP), etc.

The positive active material may include a lithium nickel oxide represented by Chemical Formula 1 below, a lithium cobalt oxide represented by Chemical Formula 2, a lithium phosphoric acid iron compound represented by Chemical Formula 3, or combinations thereof.

Liₐ₁Niₓ₁M¹_{y1}M²_{1-x1-y1}O₂ [Chemical Formula 1]

In the Chemical Formula 1, 0.9≤a1≤1.8, 0.3≤x1≤1, 0≤y1≤0.7, and M¹ and M² may each independently be Al, B, Ba, Ca, Ce, Co, Cr, Cu, F, Fe, Mg, Mn, Mo, Nb, P, S, Si, Sr, Ti, V, W, or Zr.

Liₐ₂Coₓ₂M³₁₋ₓ₂O₂ [Chemical Formula 2]

In Chemical Formula 2, 0.9≤a2≤1.8, 0.6≤x2≤1, M³ may be Al, B, Ba, Ca, Ce, Cr, Cu, F, Fe, Mg, Mn, Mo, Nb, P, S, Si, Sr, Ti, V, W, or Zr.

Liₐ₃Feₓ₃M⁴₁₋ₓ₃PO₄ [Chemical Formula 3]

In Chemical Formula 3, 0.9≤a3<1.8, 0.6≤x3<1, and M⁴ may be Al, B, Ba, Ca, Ce, Co, Cr, Cu, F, Fe, Mg, Mn, Mo, Nb, P, S, Si, Sr, Ti, V, W, or Zr.

The average particle diameter D50 of the positive active material may be 1 μm to 25 μm, e.g., 3 μm to 25 μm, 5 μm to 25 μm, 5 μm to 20 μm, 8 μm to 20 am, or 10 μm to 18 μm. The positive active material with these particle diameter ranges may be harmoniously mixed with other components within the positive active material layer and may achieve high capacity and high energy density.

The positive active material may be in a form of a secondary particle made by coagulating or agglomerating a plurality of primary particles, or may be in the form of a single particle. In an implementation, the positive active material may be a spherical shape or a shape close to a spherical shape, or may be polyhedral or irregular.

### A Sulfide Solid Electrolyte

The sulfide solid electrolyte may include, e.g., Li₂S—P₂S₅, Li₂S—P₂S—LiX (X is a halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (m and n are each an integer and Z is Ge, Zn, or Ga), Li₂S—GeS₂, Li₂S—SiS₂—Li₃PO₄, Li₂S—SiS₂—LipMOq (p and q are integers and M is P, Si, Ge, B, Al, Ga, or In), or the like.

The sulfide solid electrolyte may be obtained by, e.g., mixing Li₂S and P₂S₅ in a mole ratio of about 50:50 to about 90:10 or about 50:50 to about 80:20 and selectively heat treating. Within the above mixing ratio ranges, a sulfide solid electrolyte having excellent ionic conductivity may be prepared. The ionic conductivity may be further improved by adding SiS₂, GeS₂, B₂S₃, or the like as other components thereto.

Mechanical milling or a solution method may be applied as a mixing method of a sulfur-including raw material to produce the sulfide solid electrolyte. The mechanical milling method may make starting materials into particulates by putting starting materials, ball mills, or the like in a reactor and vigorously stirring them. The solution method may be performed by mixing the starting materials in a solvent to obtain a solid electrolyte as a precipitate. In an implementation, heat treatment may be performed after the mixing, the solid electrolyte crystals may become stronger, and ion conductivity may be improved. In an implementation, the sulfide solid electrolyte may be manufactured by mixing the sulfur-including raw materials and heat treating it more than twice, and in this case, the sulfide solid electrolyte with high ion conductivity and robustness may be manufactured.

In an implementation, the sulfide solid electrolyte particle may be an argyrodite-type sulfide. The argyrodite-type sulfide may be expressed as, e.g., a Chemical Formula of LiₐM_{b}P_{c}S_{d}Aₑ (a, b, c, d, and e are all 0 or more and 12 or less, M is a combination of a metal excluding Li or a plurality of metals excluding Li, A is F, Cl, Br, or I). In an implementation, it may be expressed as a Chemical Formula of Li₇₋ₓPS₆₋ₓAₓ (x is 0.2 or more and 1.8 or less, and A is F, Cl, Br, or I). The argyrodite-type sulfide may be, e.g., Li₃PS₄, Li₇P₃S₁₁, Li₇PS₆, Li₆PS₅Cl, Li₆PS₅Br, Li_{5.8}PS_{4.8}Cl1.2, Li_{6.2}PS_{5.2}Br_{0.8}, etc.

This sulfide solid electrolyte including the argyrodite-type sulfide may have high ionic conductivity close to about 10⁻⁴ to about 10⁻² S/cm, which is ionic conductivity of a liquid electrolyte, at room temperature and thus, may form close coupling between the positive active material and the solid electrolyte without deteriorating the ion conductivity, and furthermore, form a close interface between the electrode layer and the solid electrolyte layer. An all-solid-state battery including the same may exhibit improved battery performance such as rate capability, Coulomb efficiency, and cycle-life characteristics.

The argyrodite-type sulfide solid electrolyte may be produced, e.g., by mixing sulfidelithium, phosphosulfide, and selectively halogenated lithium. After mixing them, heat treatment may be performed. The heat treatment may include, e.g., two or more heat treatment steps.

The average particle diameter D50 of the sulfide solid electrolyte particle according to one embodiment may be 5.0 μm or less, e.g., 0.1 μm to 5.0 μm, 0.1 μm to 4.0 μm, 0.1 μm to 3.0 μm, 0.5 μm to 2.0 μm, or 0.1 μm to 1.5 μm. In an implementation, the sulfide solid electrolyte particle may be a small particle with an average particle diameter D50 of 0.1 μm to 1.0 μm, or a large particle with an average particle diameter D50 of 1.5 μm to 5.0 μm, depending on the position or purpose for which it is used. The sulfide solid electrolyte particles in these particle diameter ranges may effectively penetrate between the solid particles within the battery, and may have excellent contact with the electrode active material and connectivity between the solid electrolyte particles. The average particle diameter of the sulfide solid electrolyte particle may be measured using a microscope image. In an implementation, a particle size distribution may be obtained by measuring the size of about 20 particles in a scanning electron microscope image, and D50 may be calculated from this.

The content of the solid electrolyte in the positive electrode for the all-solid battery may be 0.5 wt % to 35 wt %, e.g., 1 wt % to 35 wt %, 5 wt % to 30 wt %, 8 wt % to 25 wt %, or 10 wt % to 20 wt %. This is the content of the total weight of the components within the positive electrode, and may be said to be the content of the total weight of the positive active material layer.

In an implementation, the positive active material layer may include, for 100 wt % of the positive active material layer, 50 wt % to 99.35 wt % of the positive active material, 0.5 wt % to 35 wt % of the sulfide solid electrolyte, 0.1 wt % to 10 wt % of a fluorinated resin binder, and 0.05 wt % to 5 wt % of a vanadium oxide. Within these content ranges, the positive electrode for the all-solid rechargeable battery may maintain high adherence while implementing high-capacity and high ion conductivity, and a viscosity of the positive electrode composition may be maintained at an appropriate level, thereby improving processability.

### A Binder

The binder may help improve binding properties of positive active material particles with one another and with a current collector. Examples thereof may include polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

### A Conductive Material

The positive active material layer may further include a conductive material. The conductive material may provide electrode conductivity, and examples of the conductive material may include: a carbon material such as natural graphite, artificial graphite, carbon black, acetylene black, ketjen black, a carbon fiber, carbon nanotube, and the like; a metal material of a metal powder or a metal fiber including copper, nickel, aluminum, silver, and the like; a conductive polymer such as a polyphenylene derivative; or a mixture thereof.

The conductive material may be included from 0.1 wt % to 5 wt %, or 0.1 wt % to 3 wt %, with respect to the total weight of each component of the positive electrode for the all-solid battery, or with respect to the total weight of the positive active material layer. In these content ranges, the conductive materials may help improve electrical conductivity without deteriorating battery performance.

In an implementation, the positive active material layer may further include the conductive material, and the positive active material layer, for the positive active material layer of 100 wt %, may include 45 wt % to 99.25 wt % of the positive active material, 0.5 wt % to 35 wt % of the sulfide solid electrolyte, 0.1 wt % to 10 wt % of the fluorinated resin binder, 0.05 wt % to 5 wt % of the vanadium oxide, and 0.1 wt % to 5 wt % of the conductive material.

In an implementation, the positive electrode for the lithium rechargeable battery may further include an oxide inorganic solid electrolyte in addition to the solid electrolyte described above. The oxide inorganic solid electrolyte, e.g., may include Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, garnet ceramics Li₃₊ₓLa₃M₂O₁₂ (M=Te, Nb, or Zr; x is an integer of 1 to 10), or a combination thereof.

An all-Solid Rechargeable Battery

One embodiment provides an all-solid rechargeable battery including the above-described positive electrode, negative electrode, and solid electrolyte layer positioned between the positive electrode and the negative electrode. The all-solid rechargeable battery may also be expressed as an all-solid battery, or an all-solid lithium rechargeable battery.

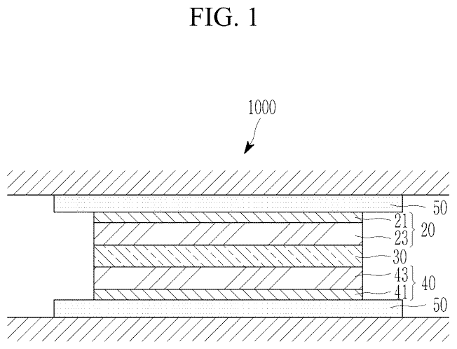

FIG. 1 is a cross-sectional view of an all-solid battery.

Referring to FIG. 1, an all-solid rechargeable battery 1000 may be a structure in which an electrode assembly in which a negative electrode 40 (including a negative current collecting layer 41 and a negative active material layer 43), a solid electrolyte layer 30, and a positive electrode 20 (including a positive active material layer 23 and a positive electrode collecting layer 21) are stacked is accommodated in a case such as a pouch or a can. The all-solid rechargeable battery 1000 may further include an elastic layer 50 outside at least one of the positive electrode 20 and the negative electrode 40. In an implementation, as illustrated in FIG. 1, one electrode assembly may include the negative electrode 40, the solid electrolyte layer 30, and the positive electrode 20, or an all-solid battery may be manufactured by stacking two or more electrode assemblies.

### A Negative Electrode

The negative electrode for the all-solid battery may include, e.g., a current collecting layer and a negative active material layer on the current collecting layer. The negative active material layer may include a negative active material and may further include a binder, a conductive material, or a solid electrolyte.

The negative active material may include a material that can perform reversible intercalation and deintercalation of lithium ions, a lithium metal, an alloy of the lithium metal, a material doping or dedoping lithium, or a transition metal oxide.

The material that reversibly intercalates/deintercalates lithium ions may include, e.g., crystalline carbon, amorphous carbon, or a combination thereof as a carbon negative active material. The crystalline carbon may be non-shaped, or plate, flake, spherical, or fiber shaped natural graphite or artificial graphite. The amorphous carbon may be a soft carbon, a hard carbon, a mesophase pitch carbonization product, calcined coke, and the like.

The lithium metal alloy includes an alloy of lithium and a metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si negative active material or a Sn negative active material. The Si negative active material may include silicon, a silicon-carbon composite, SiOₓ (0<x<2), a Si-Q alloy, wherein Q is an alkali metal, an alkaline-earth metal, a Group 13 element, a Group 14 element, a Group 15 element, a Group 16 element, a transition metal, a rare earth element, and a combination thereof, but not Si. The Sn negative active material may include Sn, SnO₂, a Sn—R alloy, wherein R is an alkali metal, an alkaline-earth metal, a Group 13 element, a Group 14 element, a Group 15 element, a Group 16 element, a transition metal, a rare earth element, and a combination thereof, but not Sn. At least one of these materials may be mixed with SiO₂. The elements Q and R may each independently be, e.g., Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof.

The silicon-carbon composite may be a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal pitch, mesophase pitch, petroleum pitch, coal oil, petroleum heavy oil, or a polymer resin such as a phenol resin, a furan resin, or a polyimide resin. In this case, the content of silicon may be about 10 wt % to about 50 wt % based on the total weight of the silicon-carbon composite. In an implementation, the content of the crystalline carbon may be about 10 wt % to about 70 wt % based on the total weight of the silicon-carbon composite, and the content of the amorphous carbon may be about 20 wt % to about 40 wt % based on the total weight of the silicon-carbon composite. In an implementation, a thickness of the amorphous carbon coating layer may be about 5 nm to about 100 nm.

An average particle diameter (D50) of the silicon particles may be about 10 nm to about 20 μm, e.g., 10 nm to 500 nm. The silicon particles may exist in an oxidized form, and in this case, an atomic content ratio of Si:O in the silicon particles indicating a degree of oxidation may be a weight ratio of about 99:1 to about 33:67. The silicon particles may be SiOₓ particles, and in this case, the range of x in SiOₓ may be greater than about 0 and less than about 2. Here, the average particle diameter D50 is measured with a particle size analyzer using a laser diffraction method and indicates a particle where an accumulated volume is about 50 vol % in a particle distribution.

The Si negative active material or Sn negative active material may be mixed with the carbon negative active material. In an implementation, the Si negative active material or Sn negative active material and the carbon negative active material may be mixed and used, and a mixing ratio may be a weight ratio of about 1:99 to about 10:90.

In the negative active material layer, the negative active material may be included in an amount of about 95 wt % to about 99 wt % based on the total weight of the negative active material layer.

In an implementation, the negative active material layer includes a binder, and may optionally further include a conductive material. The content of the binder in the negative active material layer may be about 1 wt % to about 5 wt % based on the total weight of the negative active material layer. In an implementation, the conductive material may be further included, and the negative active material layer may include about 90 wt % to about 98 wt % of the negative active material, about 1 wt % to about 5 wt % of the binder, and about 1 wt % to about 5 wt % of the conductive material.

The binder may serve to well adhere the negative active material particles to each other and also to adhere the negative active material to the current collector. The binder may be a water-insoluble binder, a water-soluble binder, or a combination thereof.

Examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoroethylene, polyvinylidene fluoride, polyethylene, polypropylene, polyamideimide, a polyimide, or a combination thereof.

The water-soluble binder may include a rubber binder or a polymer resin binder. The rubber binder may include a styrene-butadiene rubber, an acrylated styrene-butadiene rubber, an acrylonitrile-butadiene rubber, an acrylic rubber, a butyl rubber, a fluororubber, or a combination thereof. The polymer resin binder may include polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, or a combination thereof.

In an implementation, a water-soluble binder may be used as the negative electrode binder, and a cellulose compound capable of imparting viscosity may be further included. As the cellulose compound, carboxymethyl cellulose, hydroxypropyl methylcellulose, methyl cellulose, or alkali metal salts thereof may be mixed and used. As the alkali metal, Na, K, or Li may be used. The amount of the thickener used may be about 0.1 parts by weight to about 3 parts by weight based on 100 parts by weight of the negative active material.

The conductive material may be included to provide electrode conductivity. Any electrically conductive material may be used as a conductive material unless it causes a chemical change. Examples of the conductive material may include a carbon material such as natural graphite, artificial graphite, carbon black, acetylene black, ketjen black, a carbon fiber, and the like; a metal material of a powder or a fiber including copper, nickel, aluminum, silver, and the like; a conductive polymer such as a polyphenylene derivative; or a mixture thereof.

The current collector may include a copper foil, a nickel foil, a stainless-steel foil, a titanium foil, a nickel foam, a copper foam, a polymer substrate coated with a conductive metal, or a combination thereof.

In an implementation, the negative electrode for the all-solid battery may be, e.g., a precipitation-type negative electrode. The precipitation-type negative electrode may be a negative electrode which has no negative active material during the assembly of an electrochemical battery but in which a lithium metal and the like are precipitated during the charge of the electrochemical battery and serve as a negative active material.

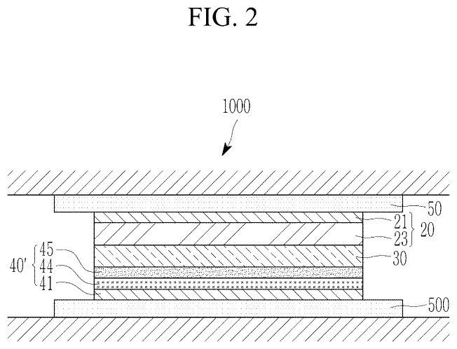

FIG. 2 is a cross-sectional view of an all-solid battery including a precipitation-type negative electrode.

Referring to FIG. 2, the precipitation-type negative electrode 40′ may include a negative current collecting layer 41 and a negative coating layer 45 on the negative current collecting layer 41. The rechargeable lithium battery having this precipitation-type negative electrode 40′ may start to be initially charged in absence of a negative active material, and a lithium metal with high density and the like may be precipitated between the negative current collecting layer 41 and the negative coating layer 45 during the charge and form a lithium metal layer 44, which may work as a negative active material. Accordingly, the precipitation-type negative electrode 40′, in the all-solid battery which is charged more than once, may include the negative current collecting layer 41, the lithium metal layer 44 on the negative current collecting layer 41, and the negative coating layer 45 on the metal layer. The lithium metal layer 44 means a layer of the lithium metal and the like precipitated during the charge of the electrochemical battery and may be called a metal layer, a negative active material layer, or the like and act as a negative active material.

The negative coating layer 45 may include a metal or a carbon material, which may play a role of a catalyst.

The metal may include gold, platinum, palladium, silicon silver, aluminum, bismuth, tin, zinc, or a combination thereof and may be composed of one selected therefrom or an alloy of more than one. The metal included in the negative electrode catalyst layer may have an average particle diameter (D50) of less than or equal to about 4 μm, for example, about 10 nm to about 4 μm.

The carbon material may be, e.g., crystalline carbon, non-graphitic carbon, or a combination thereof. The crystalline carbon may be, e.g., natural graphite, artificial graphite, mesophase carbon microbeads, or a combination thereof. The amorphous carbon may be carbon black, activated carbon, acetylene black, denka black, ketjen black, or a combination thereof.

In an implementation, the negative coating layer 45 may include the metal and the carbon material, and the metal and the carbon material may be, e.g., mixed in a weight ratio of about 1:10 to about 2:1. In an implementation, the precipitation of the lithium metal may be effectively promoted and improve characteristics of the all-solid battery. The negative coating layer 45 may include, e.g., a carbon material on which a catalyst metal is supported or a mixture of metal particles and carbon material particles.

The negative coating layer 45 may include, e.g., a metal and an amorphous carbon, and in this case, it may effectively promote the precipitation of the lithium metal.

The negative coating layer 45 may further include a binder, and the binder may be a conductive binder. In an implementation, the negative coating layer 45 may further include suitable additives such as a filler, a dispersing agent, an ion conductive agent, or the like.

The thickness of the negative coating layer 45 may be, e.g., 100 nm to 20 μm, or 500 nm to 10 μm, or 1 μm to 5 μm.

In an implementation, the precipitation-type negative electrode 40′ may further include a thin film on the surface of the negative current collecting layer 41, e.g., between the negative current collecting layer 41 and the negative coating layer 45. The thin film may include an element capable of forming alloys with lithium. The element capable of forming the alloys with lithium may be, e.g., gold, silver, zinc, tin, indium, silicon, aluminum, bismuth, or the like, which may be used alone or as an alloy of more than one. The thin film may further planarize the precipitation pattern of the lithium metal layer 44 and further improve the characteristics of the all-solid battery. The thin film may be formed, e.g., by vacuum deposition, sputtering, or plating. The thickness of the thin film may be, e.g., 1 nm to 500 nm.

### A Solid Electrolyte Layer

The solid electrolyte layer 30 may include a sulfide solid electrolyte, an oxide solid electrolyte, etc. The specific details of the sulfide solid electrolyte and the oxide solid electrolyte may be as described above.

In an implementation, the solid electrolyte included in the positive electrode 20 and the solid electrolyte included in the solid electrolyte layer 30 may include the same compound or different compounds. In an implementation, both the positive electrode 20 and the solid electrolyte layer 30 may include an argyrodite-type sulfide solid electrolyte, and the overall performance of the all-solid rechargeable battery may be improved. In an implementation, both the positive electrode 20 and the solid electrolyte layer 30 may include the coated solid electrolyte described above, and the all-solid rechargeable battery may realize a high-capacity, high energy density, and excellent initial efficiency and lifespan characteristic.

In an implementation, the average particle diameter D50 of the solid electrolyte included in the positive electrode 20 may be smaller than the average particle diameter D50 of the solid electrolyte included in the solid electrolyte layer 30. In this case, the overall performance may be improved by maximizing the energy density of the all-solid battery and increasing the mobility of lithium ions. In an implementation, the average particle diameter D50 of the solid electrolyte included in the positive electrode 20 may be 0.1 μm to 1.0 μm, or 0.1 μm to 0.8 μm, and the average particle diameter D50 of the solid electrolyte included in the solid electrolyte layer 30 may be 1.5 μm to 5.0 μm, or 2.0 μm to 4.0 μm, or 2.5 μm to 3.5 μm. Within these particle diameter ranges, the energy density of the all-solid rechargeable battery may be maximized and the transferring of lithium ions is easy and then the resistance may be suppressed, thereby improving the overall performance of the all-solid rechargeable battery. In an implementation, the average particle diameter D50 of the solid electrolyte may be measured through a particle size analyzer using the laser diffraction method. In an implementation, about 20 particles may be selected from a microscope photo such as a scanning electron microscope to measure the particle size and obtain the particle size distribution, and the D50 value may be calculated from this.

The solid electrolyte layer may include a binder in addition to the solid electrolyte. In an implementation, the binder may include a styrene butadiene rubber, polytetrafluoroethylene, polyvinylidene fluoride, polyethylene, an acrylate polymer, or a combination thereof. The acrylate polymer may be, e.g., butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may be isobutyl isobutyrate, xylene, toluene, benzene, hexane, or a combination thereof.

The thickness of the solid electrolyte layer may be, e.g., about 10 μm to about 150 μm.

The solid electrolyte layer may further include an alkali metal salt or an ionic liquid and/or a conductive polymer.

The alkali metal salt may be, e.g., a lithium salt. The concentration of the lithium salt in the solid electrolyte layer may be 1 M or more, e.g., 1 M to 4 M.

In this case, the lithium salt may improve the ion conductivity by improving the lithium ion mobility in the solid electrolyte layer.

The lithium salt may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro(oxalato) borate (LiDFOB), lithium bis(trifluoromethanesulfonyl)imide (LiTFSI, LiN(SO₂CF₃)₂), lithium bis(fluorosulfonyl)imide, LiFSI, LiN(SO₂F)₂), LiCF₃SO₃, LiAsF₆, LiSbF₆, LiClO₄, or a mixture thereof.

In an implementation, the lithium salt may be an imide salt, e.g., lithium bis(trifluoromethanesulfonyl) imide (LiTFSI, LiN(SO₂CF₃)₂), or lithium bis(fluorosulfonyl)imide (LiFSI, LiN(SO₂F)₂). The lithium salt may maintain or improve ionic conductivity by appropriately maintaining chemical reactivity with the ionic liquid.

The ionic liquid may have a melting point below a room temperature (e.g., about 20° C. to about 27° C.), so it refers to a salt or a room temperature fusion salt that is liquid at a room temperature and consists only of ions.

The ionic liquid may be a compound including a) a positive ion, e.g., ammonium, pyrrolidinium, pyridinium, pyrimidinium, imidazole, piperidinium, pyrazole, oxazole, pyridazinium, phosphonium, sulfonium, triazole, or mixtures thereof, and b) a negative ion, e.g., BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, FSO₂₂N—, (C₂F₅SO₂)₂N—, (C₂F₅SO₂, CF₃SO₂)N—, or (CF₃SO₂)₂N—.

The ionic liquid may include, e.g., N-methyl-N-propylpyrroledium bis(trifluoromethanesulfonyl)imide, N-butyl-N-methylpyrroledium bis(3-trifluoromethylsulfonyl)imide, 1-butyl-3-methylimidazolelium bis(trifluoromethylsulfonyl)amide, or 1-ethyl-3-methylimidazoleium bis(trifluoromethylsulfonyl)amide.

A weight ratio of the solid electrolyte and the ionic liquid in the solid electrolyte layer may be about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state battery may be improved.

The all-solid rechargeable battery may be a unit cell having a structure of a positive electrode/solid electrolyte layer/negative electrode, a bi-cell having a structure of positive electrode/solid electrolyte layer/negative electrode/solid electrolyte layer/positive electrode, or a stacked battery in which the structure of the unit cell is repeated.

The shape of the all-solid battery may be a suitable shape, e.g., a coin type, a button type, a sheet type, a stack type, a cylindrical shape, a flat type, or the like. In an implementation, the all-solid-state battery may be applied to a large-sized battery used in an electric vehicle or the like. In an implementation, the all-solid-state battery may also be used in a hybrid vehicle such as a plug-in hybrid electric vehicle (PHEV). In an implementation, it may be used in a field requiring a large amount of power storage, and may be used, for example, in an electric bicycle or a power tool.

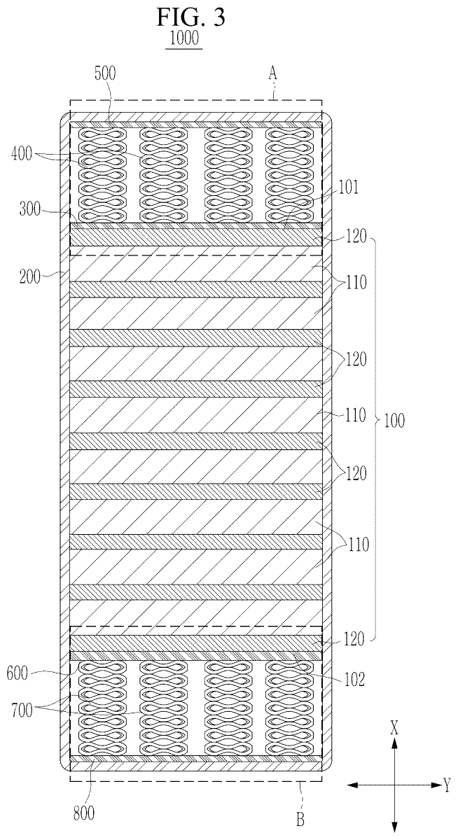

Below, the all-solid rechargeable battery according to an embodiment is described with reference to FIG. 3 to FIG. 7. The all-solid rechargeable battery according to an embodiment may be a rechargeable battery that may be repeatedly charged and discharged. Hereinafter, the positive electrode includes a cathode, and the negative electrode includes an anode.

In an implementation, the all-solid rechargeable battery according to an embodiment may include an all-solid cell stack including a plurality of all-solid unit cells stacked in one direction. In an implementation, referring to FIG. 2, each of the plurality of all-solid unit cells in the all-solid cell stack may include an all-solid battery including the precipitation-type negative electrode described above, so the thickness may vary due to the lithium metal layer formed during the charging.

In an implementation each of the plurality of all-solid unit cells of the all-solid cell stack of the all-solid rechargeable battery according to an embodiment may include the all-solid battery including the negative electrode described above with reference to FIG. 1.

FIG. 3 is a cross-sectional view showing an all-solid rechargeable battery according to an embodiment.

Referring to FIG. 3, an all-solid rechargeable battery 1000 according to an embodiment may include an all-solid cell stack 100, a case 200, a first end plate 300, a plurality of first metal wave springs 400, a second end plate 500, a third end plate 600, a plurality of second metal wave springs 700, and a fourth end plate 800.

The all-solid cell stack 100 may be inside the case 200. The all-solid cell stack 100 may include a plurality of all-solid unit cells 110 and a plurality of cushioning pads 120.

The plurality of all-solid unit cells 110 may be stacked in the first direction X. The plurality of all-solid unit cells 110 may each include a negative electrode, a positive electrode, and a solid electrolyte layer. In an implementation, the first direction X may include a vertical direction.

The negative electrode may include the negative electrode included in the above-mentioned all-solid rechargeable battery or the precipitation-type negative electrode. The negative electrode may have a plate or a foil shape.

The positive electrode may be on the negative electrode with the solid electrolyte layer in between. The positive electrode may include the positive electrode included in the all-solid rechargeable battery described above. The positive electrode may have a plate or a foil shape.

The solid electrolyte layer may be between the negative electrode and the positive electrode. The solid electrolyte layer may include the solid electrolyte layer included in the all-solid rechargeable battery described above. The solid electrolyte layer may have a layer form between the negative electrode and the positive electrode.

Each of the plurality of all-solid unit cells 110 may have suitable stacking structures. In an implementation, the all-solid unit cell 110 may have a unit cell with a structure of the positive electrode/solid electrolyte layer/negative electrode, a bicell with a structure of the positive electrode/solid electrolyte layer/negative electrode/solid electrolyte layer/positive electrode, or a stacked battery structure with a repeating structure of the unit cell.

The plurality of cushioning pads 120 may be between the plurality of all-solid unit cells 110 stacked in the first direction X. Each of the plurality of cushioning pads 120 may be between the neighboring all-solid unit cells 110 among the plurality of all-solid unit cells 110. Among the plurality of cushioning pads 120, the cushioning pad 120 at the uppermost layer of the first direction may be positioned between the first end plate 300 and the all-solid unit cell 110, which is on the uppermost layer among the plurality of all-solid unit cells 110. Among the plurality of cushioning pads 120, the cushioning pad 120 at the bottom of the first direction may be between the third end plate 600 and the all-solid unit cell 110, which is on the lowest level among the plurality of all-solid unit cells 110. The plurality of cushioning pads 120 may include a suitable elastic layer for all-solid rechargeable batteries 1000.

The case 200 may store or accommodate the all-solid cell stack of 100 in an internal space thereof. The case 200 may have, e.g., a metal can shape, a pouch shape, or the like. The case 200 may have a square pillar shape, or a polygonal pillar shape such as a triangular pillar shape, a pentagonal pillar shape, a hexagonal pillar shape, a heptagonal pillar shape, an octagonal pillar shape, a circular pillar shape, an elliptical pillar shape, or a loop pillar shape. In an implementation, suitable coating layers may be coated on the inner and outer surfaces of the case 200.

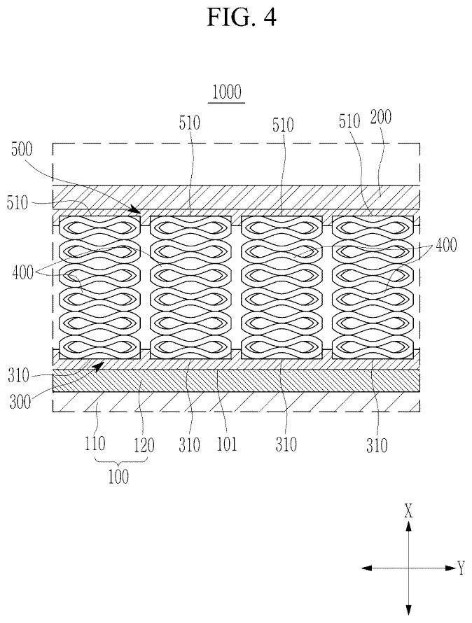

FIG. 4 is an enlarged cross-sectional view of a part A in FIG. 3.

Referring to FIG. 3 and FIG. 4, the first end plate 300 may be between the first end portion 101 and the case 200, e.g., in the first direction X of the all-solid cell stack 100. The first end plate 300 may be between the cushioning pad 120, which is on the top layer of the first direction X of the all-solid cell stack 100, and the plurality of first metal wave springs 400. The first end plate 300 may be in contact (e.g., direct contact) with the cushioning pad 120 and the plurality of first metal wave springs 400. The first end plate 300 may press the all-solid cell stack 100 in the first direction by an elasticity or elastic bias by or from the plurality of first metal wave springs 400. The first end plate 300 may include a plurality of first depressed portions 310.

The plurality of first depressed portions 310 may be spaced apart from each other in a second direction Y, which intersects the first direction X. In an implementation, the second direction Y may include a horizontal direction in FIG. 3. The plurality of first depressed portions 310 may have a depressed shape from the (e.g., inner) surface of the first end plate 300. The plurality of first metal wave springs 400 may be respectively inserted into or at least partially accommodated in the plurality of first depressed portions 310. By inserting and supporting the plurality of first metal wave springs 400 in the plurality of first depressed portions 310, the deviation of the plurality of first metal wave springs 400 from the plurality of first depressed portions 310 may be suppressed.

In an implementation, the first end plate 300 may have a plate shape and may include, e.g., aluminum or stainless steel. In an implementation, the first end plate 300 may include suitable materials, e.g., polymer, amorphous, and ceramic.

The plurality of first metal wave springs 400 may be between the first end plate 300 and the case 200. The plurality of first metal wave springs 400 may be between the first end plate 300 and the second end plate 500. The plurality of first metal wave springs 400 may be in contact (e.g., direct contact) with the first end plate 300 and the second end plate 500. The plurality of first metal wave springs 400 may be spaced apart from each other in the second direction Y while being between the first end plate 300 and the second end plate 500. The plurality of first metal wave springs 400 may be respectively inserted into the plurality of first depressed portions 310 of the first end plate 300 and the plurality of second depressed portions 510 of the second end plate 500 and may be supported to or in the first depressed portions 310 and the second depressed portions 510. In an implementation, the plurality of first metal wave springs 400 may be inserted into and supported on the plurality of first depressed portions 310 and the plurality of second depressed portions 510 between the first end plate 300 and the second end plate 500, and the deviation of the plurality of first metal wave springs 400 from the plurality of first depressed portions 310 of the first end plate 300 and the plurality of second depressed portions 510 of the second end plate 500 may be suppressed.

The plurality of first metal wave springs 400 may each include a metal wave spring. Each of the plurality of first metal wave springs 400 may include the metal wave spring, and it may have a relatively greater elastic recovery, even though it may have a thinner thickness in the first direction, compared to a coil spring. Accordingly, the thickness of the all-solid rechargeable battery 1000 in the first direction X may be thinner.

In an implementation, each of the plurality of first metal wave springs 400 may include the metal wave spring, and even though the thickness of the first direction X of the all-solid cell stack 100 could change during the charge and discharge, due to the elastic recovery of the plurality of first metal wave springs 400, the first end plate 300 may uniformly press the all-solid cell stack 100 in the first direction X. For example, the plurality of first metal wave springs 400 may be elastically biased in the first direction and thus may press the first end plate 300 against the all-solid cell stack.

In an implementation, as the plurality of first metal wave springs 400 may each include a metal wave spring, there may be no change in physical characteristics over a wide temperature range (e.g., −20° C. to 80° C.), which could otherwise occur in a metal, compared to a polymer elasticity layer, in the wide temperature range, and the first end plate 300 may uniformly press the all-solid cell stack 100 in the first direction due to the elasticity recovery (e.g., elastic bias) of the plurality of first metal wave springs 400.

In an implementation, the plurality of first metal wave springs 400 may each include the metal wave spring, the all-solid cell stack 100 may have the elasticity in the first direction X and may be supported to the plurality of first metal wave springs 400 and the first end plate 300, and the impact resistance of the all-solid rechargeable battery 1000 may be improved.

In an implementation, the plurality of first metal wave springs 400 may each include the metal wave spring, the metal's inherent thermal conductivity may be improved compared to the polymer elasticity layer, heat from the all-solid cell stack 100 may be conducted and radiated through the first end plate 300 and the plurality of first metal wave springs 400, and a heat dissipation effect for the all-solid cell stack 100 may be improved.

In an implementation, by including the plurality of first metal wave springs 400 and the first end plate 300, corresponding to the all-solid cell stack 100, whose thickness may change during the charge and discharge, it is possible to provide the all-solid rechargeable battery 1000 of which the all-solid cell stack 100 may be uniformly pressed over a wide temperature range, the impact resistance may be improved, the heat dissipation effect for the all-solid cell stack 100 may be improved, the entire thickness may become thinner, and simultaneously, the energy density may be improved compared to the thickness.

In an implementation, each of the plurality of first metal wave springs 400 may include a ring type wave spring. In an implementation, the lifespan may be improved compared to a flat type wave spring, and simultaneously the generation of a powder due to the friction by a spring elasticity recovery may be suppressed. The flat type of wave spring may include a plate type of wave spring whose longitudinal cross-section has a wave shape.

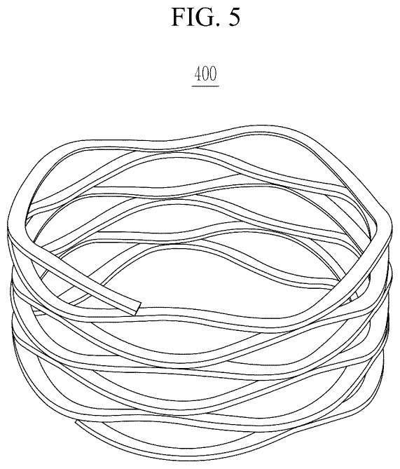

FIG. 5 is a view showing an example of a first metal wave spring of an all-solid rechargeable battery according to an embodiment.

Referring to FIG. 5, as an example of the first metal wave spring 400, the first metal wave spring 400 may include a wave spring in which waves that are symmetrical to each other in form are stacked and extended in a direction in which the elasticity restoring force is generated. In an implementation, the first metal wave spring 400 may include a crest to crest wave spring.

In an implementation, the first metal wave spring 400 may include the wave spring in which the waves with the symmetrical form to each other are stacked and extended in the direction in which the elasticity restoring force is generated, the lifespan may be improved compared to a flat type of wave spring, and simultaneously the generation of the powder due to the friction by the spring elasticity recovery may be suppressed.

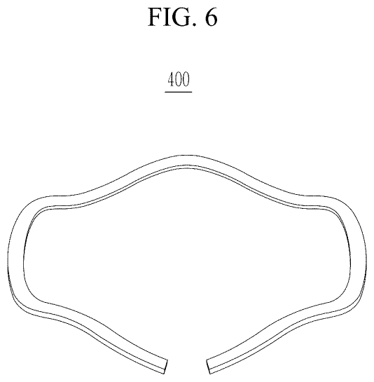

FIG. 6 is a view showing another example of a first metal wave spring of an all-solid rechargeable battery according to an embodiment.

Referring to FIG. 6, as another example of the first metal wave spring 400, the first metal wave spring 400 may include a wave spring in which a single-layer wave is extended in a ring shape. In an implementation, the first metal wave spring 400 may include a single turn wave spring. In an implementation, the first metal wave spring 400 may include the wave spring in which the single-layer wave is extended in the ring shape, and the thickness may simultaneously be thinner while improving the lifespan compared to a flat type of wave spring.

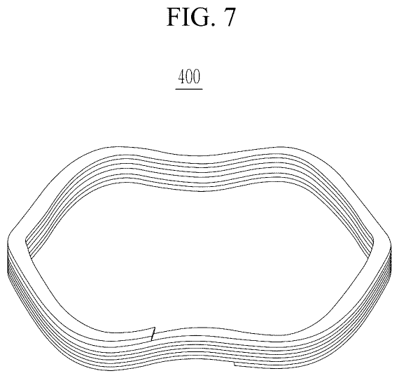

FIG. 7 is a view showing another example of a first metal wave spring of an all-solid rechargeable battery according to an embodiment.

Referring to FIG. 7, as another example of the first metal wave spring 400, the first metal wave spring 400 may include a wave spring in which waves of the same shape are stacked and extended in a direction in which an elasticity restoring force is generated. In an implementation, the first metal wave spring 400 may include a nested wave spring. In an implementation, the first metal wave spring 400 may include the wave spring in which waves of the same shape are stacked and extended in the direction in which the elasticity restoring force is generated, compared to a flat type of wave spring, and the lifespan may be improved and the thickness becomes thinner, while simultaneously the elasticity recovery may be improved.

Referring to FIG. 3 and FIG. 4, the second end plate 500 may be between the plurality of first metal wave springs 400 and the case 200. The second end plate 500 may be in contact (e.g., direct contact) with the case 200 and the plurality of first metal wave springs 400. The second end plate 500 may include the plurality of second depressed portions 510.

The plurality of second depressed portions 510 may be spaced apart from each other in the second direction Y and may correspond to (e.g., overlie or be aligned with) the plurality of first depressed portions 310 of the first end plate 300. The plurality of second depressed portions 510 may face the plurality of first depressed portions 310 with the plurality of first metal wave springs 400 in between. The plurality of second depressed portions 510 may have a depressed shape from the (e.g., inner) surface of the second end plate 500. The plurality of first metal wave springs 400 may be inserted into the plurality of second depressed portions 510, respectively. By inserting and supporting the plurality of second metal wave springs 700 in the plurality of second depressed portions 510, the deviation of the plurality of second metal wave springs 700 from the plurality of second depressed portions 510 may be suppressed.

In an implementation, the second end plate 500 may have a plate shape and may include, e.g., aluminum or stainless steel. In an implementation, the second end plate 500 may include other materials, e.g., polymer, amorphous, or ceramic.

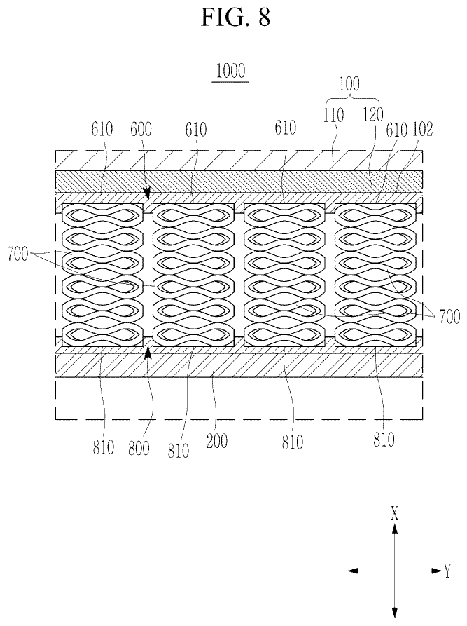

FIG. 8 is an enlarged cross-sectional view of a part B in FIG. 3.

Referring to FIG. 3 and FIG. 8, the third end plate 600 may be between the second end portion 102 of the all-solid cell stack 100 and the case 200 in the first direction X. The third end plate 600 may be between the cushioning pad 120, which is at the bottom of the all-solid cell stack 100 in the first direction X, and the plurality of second metal wave springs 700. The third end plate 600 may be in contact (e.g., direct contact) with the cushioning pad 120 and the plurality of second metal wave springs 700. The third end plate 600 may press the all-solid cell stack 100 in the first direction by the elasticity restoring force due to the plurality of second metal wave springs 700. The third end plate 600 may include a plurality of third depressed portions 610.

The plurality of third depressed portions 610 may be spaced apart from each other in the second direction Y. The plurality of third depressed portions 610 may have a depressed shape from the (e.g., inner) surface of the third end plate 600. Each of the plurality of second metal wave springs 700 may be inserted into each of the plurality of third depressed portions 610. By inserting and supporting the plurality of second metal wave springs 700 into the plurality of third depressed portions 610, the plurality of second metal wave springs 700 may be suppressed from deviating from the plurality of third depressed portions 610, e.g., may be held or fixed in position.

In an implementation, the third end plate 600 may have a plate shape and may include, e.g., aluminum or stainless steel. In an implementation, the third end plate 600 may include other materials, e.g., polymer, amorphous, or ceramic.

The plurality of second metal wave springs 700 may be between the third end plate 600 and the case 200. The plurality of second metal wave springs 700 may be between the third end plate 600 and the fourth end plate 800. The plurality of second metal wave springs 700 may be in contact (e.g., direct contact) with the third end plate 600 and the fourth end plate 800. The plurality of second metal wave springs 700 may be spaced apart from each other in the second direction Y between the third end plate 600 and the fourth end plate 800. The plurality of second metal wave springs 700 may be respectively inserted into the plurality of third depressed portions 610 of the third end plate 600 and the plurality of fourth depressed portions 810 of the fourth end plate 800, respectively, and may be supported on the third depressed portions 610 and the fourth depressed portions 810. By inserting and supporting the plurality of second metal wave springs 700 onto the plurality of third depressed portions 610 and the plurality of fourth depressed portions 810 between the third end plate 600 and the fourth end plate 800, the deviation of the plurality of second metal wave springs 700 may be suppressed from the plurality of third depressed portions 610 of the third end plate 600 and the plurality of fourth depressed portions 810 of the fourth end plate 800.

The plurality of second metal wave springs 700 may each include a metal wave spring. In an implementation, each of the plurality of second metal wave springs 700 may include the metal wave spring, and it may have greater elasticity recovery even if it has a thinner thickness in the first direction, compared to a coil spring, and thus the thickness of the all-solid rechargeable battery 1000 in the first direction X may be thinner.

In an implementation, each of the plurality of second metal wave springs 700 may include the metal wave spring, and even if the thickness of the first direction X of the all-solid cell stack 100 were to change during the charge and discharge, by the elasticity recovery of the plurality of second metal wave springs 700, the third end plate 600 may uniformly press the all-solid cell stack 100 in the first direction X.

In an implementation, the plurality of second metal wave springs 700 may each include a metal wave spring, there may be no change in physical characteristics over a wide temperature range (e.g., −20° C. to 80° C.), which could otherwise occur in a metal compared to a polymer elasticity layer, in the wide temperature range, the third end plate 600 may uniformly press the all-solid cell stack 100 in the first direction by the elasticity recovery of the plurality of second metal wave springs 700.

In an implementation, the plurality of second metal wave springs 700 may each include the metal wave spring, the all-solid cell stack 100 may have the elasticity in the first direction X and may be supported to the plurality of second metal wave springs 700 and the third end plate 600, and the impact resistance of the all-solid rechargeable battery 1000 may be improved.

In an implementation the plurality of second metal wave springs 700 may each include the metal wave spring, the metal's inherent thermal conductivity may be improved compared to the polymer elasticity layer, heat from the all-solid cell stack 100 may be conducted and radiated through the third end plate 600 and the plurality of second metal wave springs 700, and a heat dissipation effect for the all-solid cell stack 100 may be improved.

In an implementation, by including the plurality of second metal wave springs 700 and the third end plate 600, corresponding to the all-solid cell stack 100, whose thickness may change during the charge and discharge, it is possible to provide the all-solid rechargeable battery 1000 of which the all-solid cell stack 100 is uniformly pressed over a wide temperature range, the impact resistance is improved, the heat dissipation effect for the all-solid cell stack 100 is improved, the entire thickness becomes thinner, and simultaneously, the energy density is improved compared to the thickness.

In an implementation, each of the plurality of first metal wave springs 700 may include a ring type wave spring. In an implementation, the plurality of second metal wave springs 700 may each include the ring type wave spring, the lifespan may be improved compared to a flat type of wave spring, and simultaneously the generation of a powder due to the friction by a spring elasticity recovering may be suppressed. Here, the flat type of wave spring may include a plate type of wave spring whose longitudinal cross-section has a wave shape.

As an example of the second metal wave spring 700, the second metal wave spring 700 may include a wave spring in which waves of a form symmetrical to each other are stacked and extended in a direction in which an elasticity restoring force is generated.

In an implementation, the second metal wave spring 700 may include the wave spring in which the waves of the symmetrical form to each other are stacked and extended in the direction in which the elasticity restoring force is generated, the lifespan may be improved compared to a flat type of wave spring, and simultaneously the generation of the powder due to the friction by the spring elasticity recovering may be suppressed.

As another example of the second metal wave spring 700, the second metal wave spring 700 may include a wave spring in which a single-layer wave is extended in a ring shape.

In an implementation, the second metal wave spring 700 may include the wave spring in which the single-layer wave is extended in the ring shape, and the thickness may simultaneously be thinner while improving the lifespan compared to a flat type of wave spring.

As another example of the second metal wave spring 700, the second metal wave spring 700 may include a wave spring in which waves of the same shape are stacked and extended in a direction in which an elasticity restoring force is generated.

In an implementation, the second metal wave spring 700 may include the wave spring in which waves of the same shape are stacked and extended in the direction in which the elasticity restoring force is generated, compared to a flat type of wave spring, the lifespan may be improved and the thickness becomes thinner, and simultaneously the elasticity recovery may be improved.

A fourth end plate 800 may be between the plurality of second metal wave springs 700 and the case 200. The fourth end plate 800 may be in contact (e.g., direct contact) with the case 200 and the plurality of second metal wave springs 700. The fourth end plate 800 may include the plurality of fourth depressed portions 810.

The plurality of fourth depressed portions 810 may be spaced apart from each other in the second direction Y and may correspond to the plurality of third depressed portions 610 of the third end plate 600. The plurality of fourth depressed portions 810 may face the plurality of third depressed portions 610, with the plurality of second metal wave springs 700 therebetween. The plurality of fourth depressed portions 810 may have a depressed shape from the (e.g., inner) surface of the fourth end plate 800. The plurality of second metal wave springs 700 may be respectively inserted into a plurality of fourth depressed portions 810. By inserting and supporting the plurality of second metal wave springs 700 in the plurality of fourth depressed portions 810, the deviation of the plurality of second metal wave springs 700 from the plurality of fourth depressed portions 810 may be suppressed.

In an implementation, the fourth end plate 800 may have a plate shape and may include, e.g., aluminum or stainless steel. In an implementation, the fourth end plate 800 may include other materials, e.g., polymer, amorphous, and ceramic.

In an implementation, each of the plurality of first metal wave springs 400 and the plurality of second metal wave springs 700 may include the metal wave spring, it may have greater elasticity recovery even if it were to have a thinner thickness in the first direction compared to a coil spring, and thus the thickness of the all-solid rechargeable battery 1000 in the first direction X may be thinner.

In an implementation, each of the plurality of first metal wave springs 400 and the plurality of second metal wave springs 700 may include the metal wave spring, the thickness of the first direction X of the all-solid cell stack 100 may change during the charge and discharge, by the elasticity recovery of the plurality of the plurality of first metal wave springs 400 and the plurality of second metal wave springs 700, and the first end plate 300 and the third end plate 600 may uniformly press the all-solid cell stack 100 in the first direction X.

In an implementation, the plurality of first metal wave springs 400 and the plurality of second metal wave springs 700 may each include a metal wave spring, there may be no change in physical characteristics over a wide temperature range (e.g., −20° C. to 80° C.) inherent to a metal compared to a polymer elasticity layer, in the wide temperature range, and the first end plate 300 and the third end plate 600 may uniformly press the all-solid cell stack 100 in the first direction by the elasticity recovery of the plurality of the first metal wave springs 400 and the plurality of second metal wave springs 700.

In an implementation, the plurality of first metal wave springs 400 and the plurality of second metal wave springs 700 may each include the metal wave spring, the all-solid cell stack 100 may have the elasticity in the first direction X and may be supported to the plurality of first metal wave springs 400 and the first end plate 300, and the plurality of second metal wave springs 700 and the third end plate 600, and the impact resistance of the all-solid rechargeable battery 1000 may be improved.

In an implementation, the plurality of first metal wave springs 400 and the plurality of second metal wave springs 700 may each include the metal wave spring, the metal's inherent thermal conductivity may be improved compared to the polymer elasticity layer, heat from the all-solid cell stack 100 may be conducted and radiated through the first end plate 300 and the plurality of first metal wave springs 400, the third end plate 600 and the plurality of second metal wave springs 700, and the case 200, and a heat dissipation effect for the all-solid cell stack 100 may be improved.

In an implementation, by including the plurality of first metal wave springs 400 and the first end plate 300, and the plurality of second metal wave springs 700 and the third end plate 600, corresponding to the all-solid cell stack 100, whose thickness may change during the charge and discharge, it is possible to provide the all-solid rechargeable battery 1000 of which the all-solid cell stack 100 is uniformly pressed over a wide temperature range, the impact resistance may be improved, and the heat dissipation effect for the all-solid cell stack 100 may be improved, the entire thickness becomes thinner, and simultaneously, the energy density may be improved compared to the thickness.

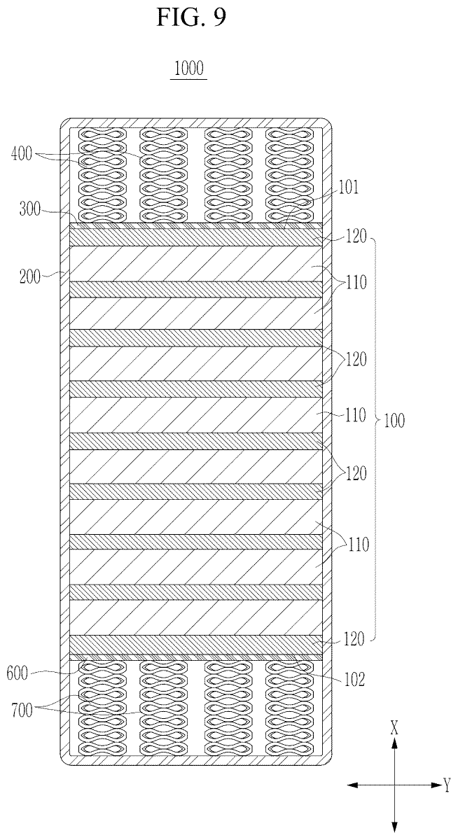

The all-solid rechargeable battery according to another embodiment is described with reference to FIG. 9.

Hereinafter, parts that are different from the all-solid rechargeable battery according to the above-described embodiment will be described.

FIG. 9 is a cross-sectional view showing an all-solid rechargeable battery according to another embodiment.

Referring to FIG. 9, an all-solid rechargeable battery 1000 according to another embodiment may include an all-solid cell stack 100, a case 200, a first end plate 300, a plurality of first metal wave springs 400, a third end plate 600, and a plurality of second metal wave springs 700. For example, as compared with the embodiment illustrated in FIG. 3, the second end plate 500 and the fourth end plate 800 may be omitted.

The plurality of first metal wave springs 400 may be between the first end plate 300 and the case 200. The plurality of first metal wave springs 400 may be in contact (e.g., direct contact) with the first end plate 300 and the case 200. The plurality of first metal wave springs 400 may be spaced apart from each other in the second direction Y between the first end plate 300 and the case 200. Each of the plurality of first metal wave springs 400 may be inserted into each of the plurality of first depressed portions of the first end plate 300 and may be supported onto the first depressed portions. By inserting and supporting the plurality of first metal wave springs 400 onto the plurality of first depressed portions between the first end plate 300 and the case 200, the deviation of the plurality of first metal wave springs 400 from between the first end plate 300 and case 200 may be suppressed.

In an implementation, the case 200 may include a plurality of other depressed portions onto which the plurality of first metal wave springs 400 are inserted and supported.

The plurality of second metal wave springs 700 may be between the third end plate 600 and the case 200. The plurality of second metal wave springs 700 may be in contact (e.g., direct contact) with the third end plate 600 and the case 200. The plurality of second metal wave springs 700 may be spaced apart from each other in the second direction Y between the third end plate 600 and the case 200. Each of the plurality of second metal wave springs 700 may be inserted into each of the plurality of third depressed portions of the third end plate 600 and supported on the third depressed portions. By inserting and supporting the plurality of second metal wave springs 700 in the plurality of third depressed portions between the third end plate 600 and the case 200, the deviating of the plurality of second metal wave springs 700 from between the third end plate 600 and the case 200 may be suppressed.

In an implementation, the case 200 may include a plurality of other depressed portions into which the plurality of second metal wave springs 700 is inserted and supported.

In an implementation, each of the plurality of first metal wave springs 400 and the plurality of second metal wave springs 700 may include the metal wave spring, it may have greater elasticity recovery even if it has a thinner thickness in the first direction compared to a coil spring, and the thickness of the all-solid rechargeable battery 1000 in the first direction X is thinner.

In an implementation, each of the plurality of first metal wave springs 400 and the plurality of second metal wave springs 700 may include the metal wave spring, and even if the thickness of the first direction X of the all-solid cell stack 100 were to change during the charge and discharge, by the elasticity recovery of the plurality of the plurality of first metal wave springs 400 and the plurality of second metal wave springs 700, the first end plate 300 and the third end plate 600 may uniformly press the all-solid cell stack 100 in the first direction X.

In an implementation, the plurality of first metal wave springs 400 and the plurality of second metal wave springs 700 may each include a metal wave spring, there may be no change in physical characteristics over a wide temperature range (e.g., −20° C. to 80° C.) inherent to a metal compared to a polymer elasticity layer, and in the wide temperature range, the first end plate 300 and the third end plate 600 may uniformly press the all-solid cell stack 100 in the first direction by the elasticity recovery of the plurality of first metal wave springs 400 and the plurality of second metal wave springs 700.

In an implementation, the plurality of first metal wave springs 400 and the plurality of second metal wave springs 700 may each include the metal wave spring, the all-solid cell stack 100 may have the elasticity in the first direction X and may be supported to the plurality of first metal wave springs 400 and the first end plate 300, and the plurality of second metal wave springs 700 and the third end plate 600, and the impact resistance of the all-solid rechargeable battery 1000 may be improved.

In an implementation, the plurality of first metal wave springs 400 and the plurality of second metal wave springs 700 may each include the metal wave spring, the metal's inherent thermal conductivity may be improved compared to the polymer elasticity layer, heat from the all-solid cell stack 100 may be conducted and radiated through the first end plate 300 and the plurality of first metal wave springs 400, the third end plate 600 and the plurality of second metal wave springs 700, and the case 200, and a heat dissipation effect for the all-solid cell stack 100 may be improved.

In an implementation, by including the plurality of first metal wave springs 400 and the first end plate 300, and the plurality of second metal wave springs 700 and the third end plate 600, corresponding to the all-solid cell stack 100, whose thickness may change during the charge and discharge, it is possible to provide the all-solid rechargeable battery 1000 of which the all-solid cell stack 100 may be uniformly pressed over a wide temperature range, the impact resistance may be improved, the heat dissipation effect for the all-solid cell stack 100 may be improved, the entire thickness may become thinner, and simultaneously, the energy density may be improved compared to the thickness.

By way of summation and review, all-solid rechargeable batteries may be safer as there may be little or no risk of an explosion due to an electrolyte solution leakage, and may be easy to manufacture thin batteries.

Some all-solid rechargeable battery may include an all-solid cell stack including a plurality of all-solid unit cells stacked in one direction, a case for storing the all-solid cell stack inside, and a pressurizer for pressurizing the all-solid cell stack and the case.

One or more embodiments may provide an all-solid rechargeable battery in which an all-solid cell stack may be uniformly pressed over a wide temperature range, impact resistance may be improved, an entire thickness may be reduced, and simultaneously energy density may be improved, compared to thickness, in response to the all-solid cell stack whose thickness may change during charge and discharge.

According to an embodiment, the all-solid rechargeable battery in which an all-solid cell stack is uniformly pressed over a wide temperature range, impact resistance is improved, an entire thickness is reduced, and simultaneously energy density is improved compared to a thickness, in response to the all-solid cell stack whose thickness may change during a charge and discharge may be provided.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An all-solid rechargeable battery, comprising:
an all-solid cell stack comprising a plurality of all-solid unit cells stacked in a first direction;
a case accommodating the all-solid cell stack therein;
a first end plate between a first end portion of the all-solid cell stack in the first direction and the case; and
a plurality of first metal wave springs between the first end plate and the case.

2. The all-solid rechargeable battery as claimed in claim 1, wherein the plurality of first metal wave springs are in contact with the first end plate.

3. The all-solid rechargeable battery as claimed in claim 2, wherein:
the first end plate comprises a plurality of first depressed portions spaced apart from each other in a second direction intersecting the first direction, and
the plurality of first metal wave springs are each inserted into the plurality of first depressed portions.

4. The all-solid rechargeable battery as claimed in claim 3, further comprising a second end plate between the plurality of first metal wave springs and the case and in contact with the plurality of first metal wave springs.

5. The all-solid rechargeable battery as claimed in claim 4, wherein:
the second end plate comprises a plurality of second depressed portions spaced apart from each other in the second direction and corresponding to the plurality of first depressed portions of the first end plate, and
the plurality of first metal wave springs are each inserted into the plurality of second depressed portions.

6. The all-solid rechargeable battery as claimed in claim 4, wherein the second end plate is in contact with the case.

7. The all-solid rechargeable battery as claimed in claim 2, wherein the plurality of first metal wave springs are in contact with the case.

8. The all-solid rechargeable battery as claimed in claim 1, wherein the plurality of first metal wave springs each comprise a ring type wave spring.

9. The all-solid rechargeable battery as claimed in claim 8, wherein the ring type wave spring comprises a wave spring of which waves with a shape symmetrical to each other are stacked and extended in a direction in which the wave spring is elastically biased.

10. The all-solid rechargeable battery as claimed in claim 8, wherein the ring type wave spring comprises a wave spring in which a single-layer wave is extended in a ring shape.

11. The all-solid rechargeable battery as claimed in claim 8, wherein the ring type wave spring comprises a wave spring in which waves of the same shape are stacked and extended in a direction in which the wave spring is elastically biased.

12. The all-solid rechargeable battery as claimed in claim 1, further comprising:
a third end plate between a second end portion of the all-solid cell stack in the first direction and the case; and
a plurality of second metal wave springs between the third end plate and the case.

13. The all-solid rechargeable battery as claimed in claim 12, wherein the plurality of second metal wave springs contact the third end plate.

14. The all-solid rechargeable battery as claimed in claim 13, wherein:
the third end plate comprises a plurality of third depressed portions spaced apart from each other in a second direction intersecting the first direction, and
the plurality of second metal wave springs are each inserted into the plurality of third depressed portions.

15. The all-solid rechargeable battery as claimed in claim 14, further comprising a fourth end plate positioned between the plurality of second metal wave springs and the case and in contact with the plurality of second metal wave springs.

16. The all-solid rechargeable battery as claimed in claim 15, wherein:
the fourth end plate comprises a plurality of fourth depressed portions spaced apart from each other in the second direction and corresponding to the plurality of third depressed portions of the third end plate, and
the plurality of second metal wave springs are each inserted into the plurality of fourth depressed portions.

17. The all-solid rechargeable battery as claimed in claim 15, wherein the fourth end plate is in contact with the case.

18. The all-solid rechargeable battery as claimed in claim 12, wherein the plurality of second metal wave springs are in contact with the case.

19. The all-solid rechargeable battery as claimed in claim 1, wherein the all-solid cell stack further comprises a plurality of cushioning pads between the plurality of all-solid unit cells.

20. The all-solid rechargeable battery as claimed in claim 1, wherein each of the all-solid unit cells comprises:
a negative electrode;
a positive electrode on the negative electrode; and
a solid electrolyte layer between the negative electrode and the positive electrode.
